(19) United States
(12) Patent Application Publication
(10) Pub. No.: US 2023/0061578 A1
(43) Pub. Date: Mar. 2, 2023

(54) Vehicle Platforms

(71) Applicant: Sullivan Ag Services LLC, Silex, MO (US)

(72) Inventors: Sam SULLIVAN, Silex, MO (US); William WATNER, Delia, KS (US)

(21) Appl. No.: 17/899,517

(22) Filed: Aug. 30, 2022

Related U.S. Application Data
(60) Provisional application No. 63/239,003, filed on Aug. 31, 2021.

(51) Int. Cl. B60P 3/06; B60P 1/43; A01D 75/00

(52) U.S. Cl. CPC B60P 3/06; B60P 1/43; A01D 75/00

(57) ABSTRACT

A platform is provided for supporting a vehicle on a combine. The platform includes a frame, and at least one guide supported by the frame. The at least one guide is configured to receive at least one wheel of a vehicle to thereby position the vehicle on the frame. The platform also includes a mount coupled to the frame and configured to connect the frame to a feeder house of the combine.

### CROSS-REFERENCE TO RELATED APPLICATION

This application claims the benefit of, and priority to, U.S. Provisional Application No. 63/239,003, filed on Aug. 31, 2021. The entire disclosure of the above application is incorporated herein by reference.

### FIELD

The present disclosure generally relates to platforms for use in supporting vehicles (e.g., ATVs, four-wheelers, cars, trucks, etc.) on drivable or moveable machinery such as, for example, combines, loaders, tractors, backhoes, skidders, etc., whereby the vehicles may be transported by the machinery as desired.

### BACKGROUND

This section provides background information related to the present disclosure which is not necessarily prior art.

Agricultural and construction machinery often are configured for use with different attachments. For example, combines are often used to harvest crops from fields. In connection therewith, various different headers may be interchangeably coupled to the combines and used with the combines to allow for harvesting and/or otherwise processing different crops. In particular, corn headers may be used to harvest corn from fields and grain headers may be used to harvest wheat, etc.

### SUMMARY

This section provides a general summary of the disclosure, and is not a comprehensive disclosure of its full scope or all of its features.

Example embodiments of the present disclosure are generally directed to platforms provided for supporting vehicles on machines (e.g., on combines, loaders, tractors, backhoes, skidders, etc.), whereby the machines may be moved (e.g., driven, etc.) with the platforms coupled thereto to thereby also transport the vehicles on the platforms. In one example embodiment, such a platform generally includes a frame, and at least one guide supported by the frame. The at least one guide is configured to receive at least one wheel (or at least one track) of a vehicle to thereby position the vehicle on the frame (e.g., with the at least one wheel or at least one track of the vehicle positioned in or on the at least one guide, etc.). The platform also generally includes a mount coupled to the frame and configured to connect (e.g., releasably, removeably, etc.) the frame to mounting structure of a machine (e.g., lugs of a feeder house of a combine, etc.).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example vehicle platform of the present disclosure illustrated coupled to a combine;

FIG. 2 is a perspective view of the vehicle platform of FIG. 1 removed from the combine;

FIG. 3 is a perspective view of the vehicle platform of FIG. 2;

FIG. 4 is another perspective view of the vehicle platform of FIG. 2;

FIGS. 5 and 6 are perspective views of the vehicle platform of FIG. 2 with a vehicle positioned on the platform;

FIGS. 7 and 8 are perspective views of the vehicle platform of FIG. 2 illustrating the combine in position to couple the vehicle platform of FIG. 2 to a feeder house of the combine; and

FIGS. 9-14 are perspective views illustrating the vehicle platform of FIGS. 7 and 8 coupling to the feeder house of the combine.

Corresponding reference numerals indicate corresponding parts throughout the several views of the drawings.

### DESCRIPTION

Example embodiments will now be described more fully with reference to the accompanying drawings. The description and specific examples included herein are intended for purposes of illustration only and are not intended to limit the scope of the present disclosure.

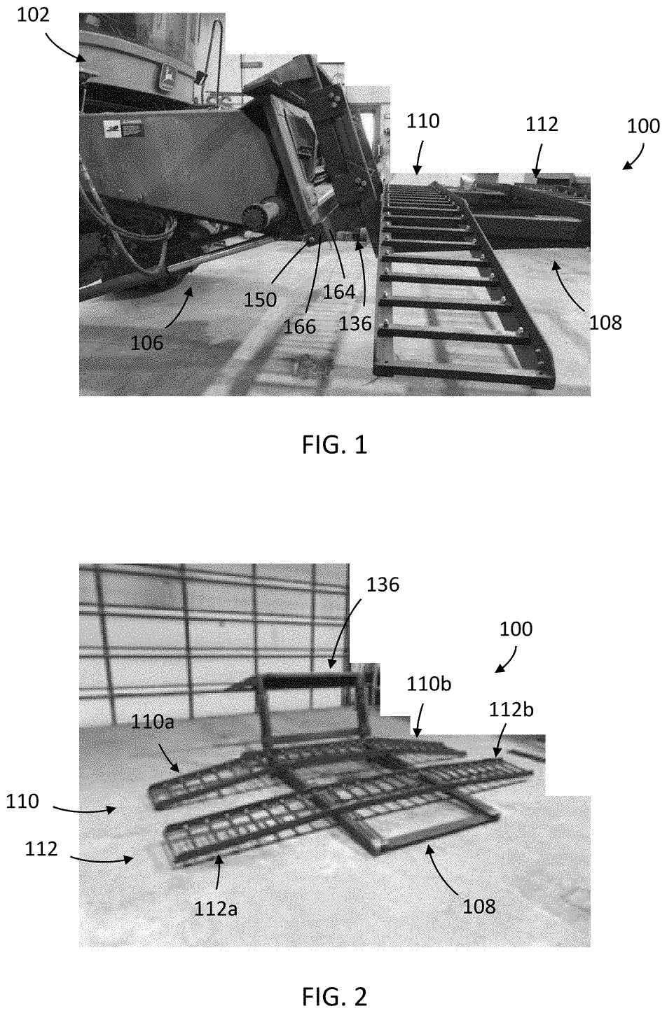

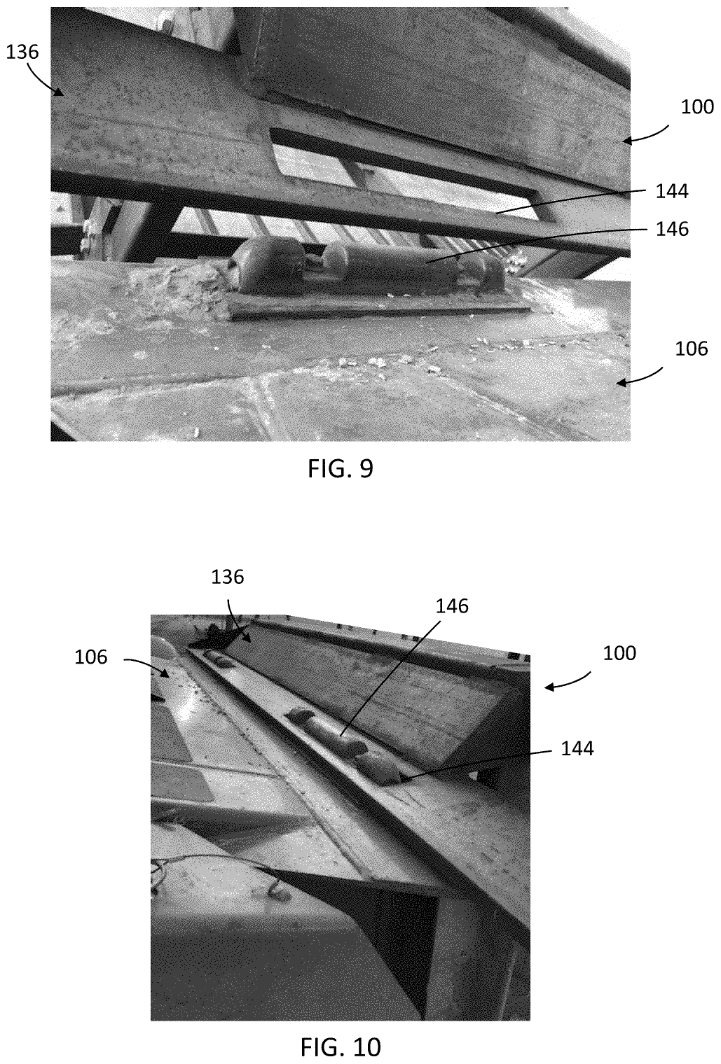

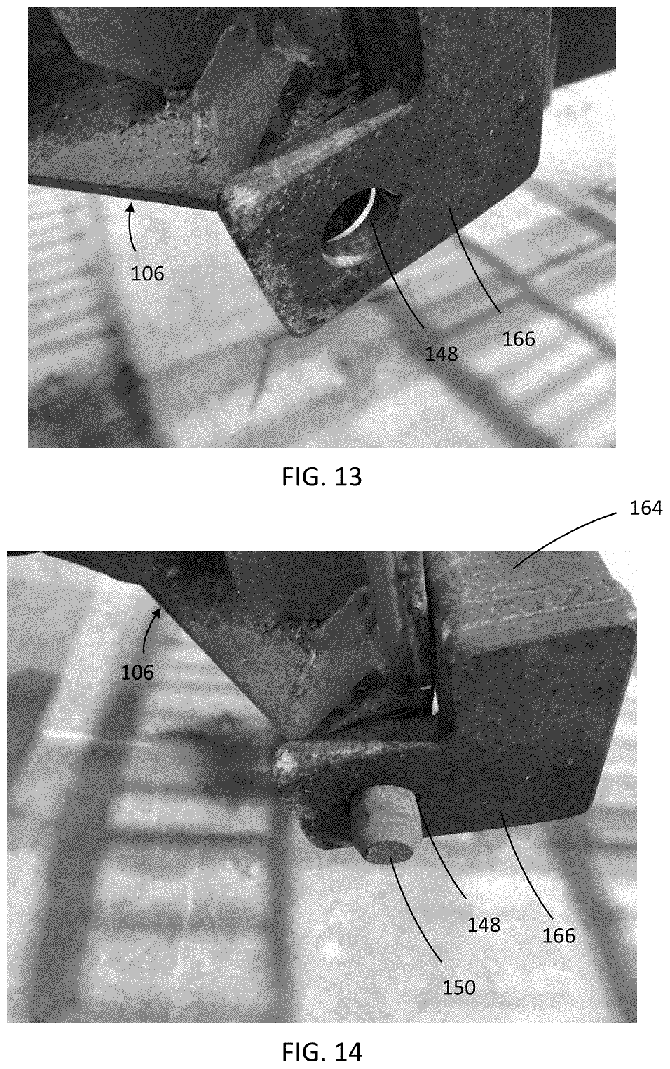

FIGS. 1-14 illustrate an example embodiment of a vehicle platform 100 for use in supporting, transporting, holding, storing, etc. a vehicle on a combine 102 (e.g., vehicle 104 as shown in FIGS. 5-6, 8, and 11-12; etc.). As will be described, the vehicle 104 may be positioned on the platform 100, and the platform 100 may be coupled (e.g., releasably, etc.) to the combine 102 (e.g., at a feeder house 106 of the combine 102 in place of a header, etc.). In this way, the combine 102 may be used to hold and transport the vehicle 104, as desired, by driving the combine 102 with the platform 100 coupled thereto (and the vehicle 104 positioned on the platform 100). It should be appreciated that any suitable vehicle (or multiple vehicles) may be positioned on the platform 100, and transported by the combine 102, within the scope of the present disclosure, including, for example, one or more all-terrain vehicles (ATVs), one or more side-by-side vehicles, one or more motorcycle vehicles, one or more golf cart vehicles, one or more car vehicles, one or more truck vehicles, etc.

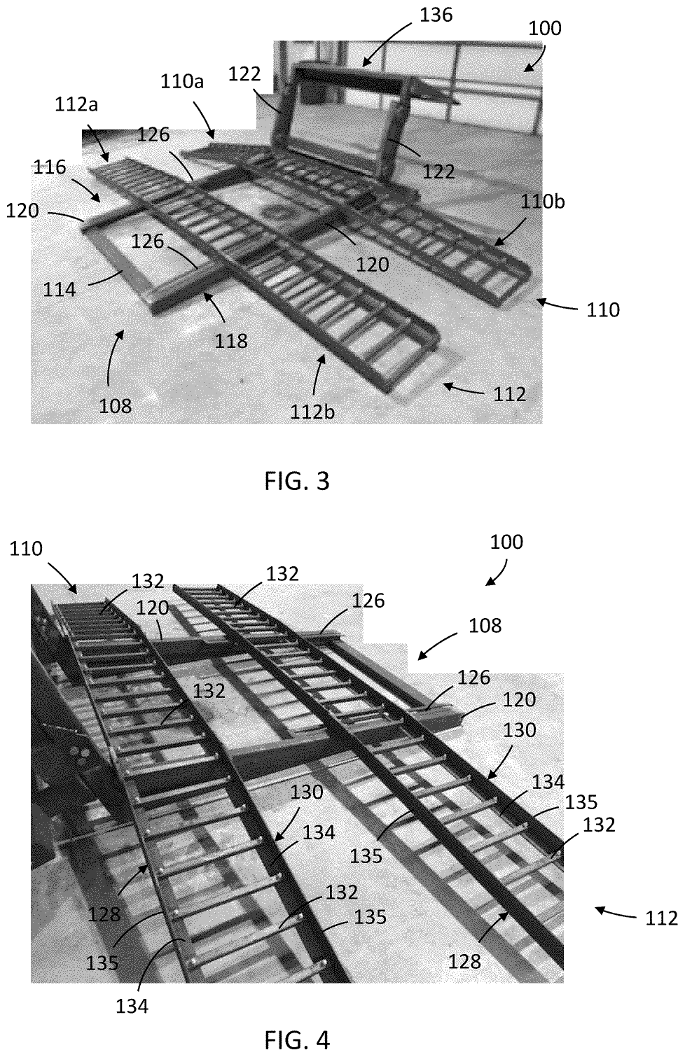

As shown in FIGS. 1 and 2, the platform 100 generally includes a frame 108 (or base), and first and second wheel (or tire) guides 110, 112 coupled to and supported by the frame 108. In the illustrated embodiment, the platform 100 includes the two guides 110, 112 positioned on the frame 108 and oriented generally parallel to each other to accommodate left and right wheels of the vehicle 104 (in positioning the vehicle 104 on the platform 100) (see, FIGS. 5 and 6). It should be appreciated, though, that more or fewer than the two guides 110, 112 may be associated with the frame 108, for example, to accommodate wheel configurations of different vehicles. For instance, a single guide may be positioned on the frame 108 to accommodate a vehicle having inline wheels (however, any number of guides positioned on the frame 108 may also accommodate such a vehicle). Or, three guides may be positioned on the frame 108 to accommodate three-wheeled vehicles (e.g., a three-wheel ATV, etc.) as well as conventional four-wheeled vehicles, etc. In general, any suitable or desired number of guides may be positioned on the frame 108 of the platform 100 at desired spacing(s) to accommodate desired vehicles. That said, in some example embodiments, the frame 108 may include a single piece or sheet of material positioned on (and/or supported by and/or coupled to) the frame 108, whereby the single piece or sheet of material generally defines a floor on the frame 108 and, broadly, may be considered a guide herein, to thereby support the vehicle 104 (and support wheels or tires of the vehicle 104) on the platform 100. Further, it should be appreciated that the guides 110, 112 of the frame may 108 may also be configured for use with vehicles having tracks (instead of wheels), etc.

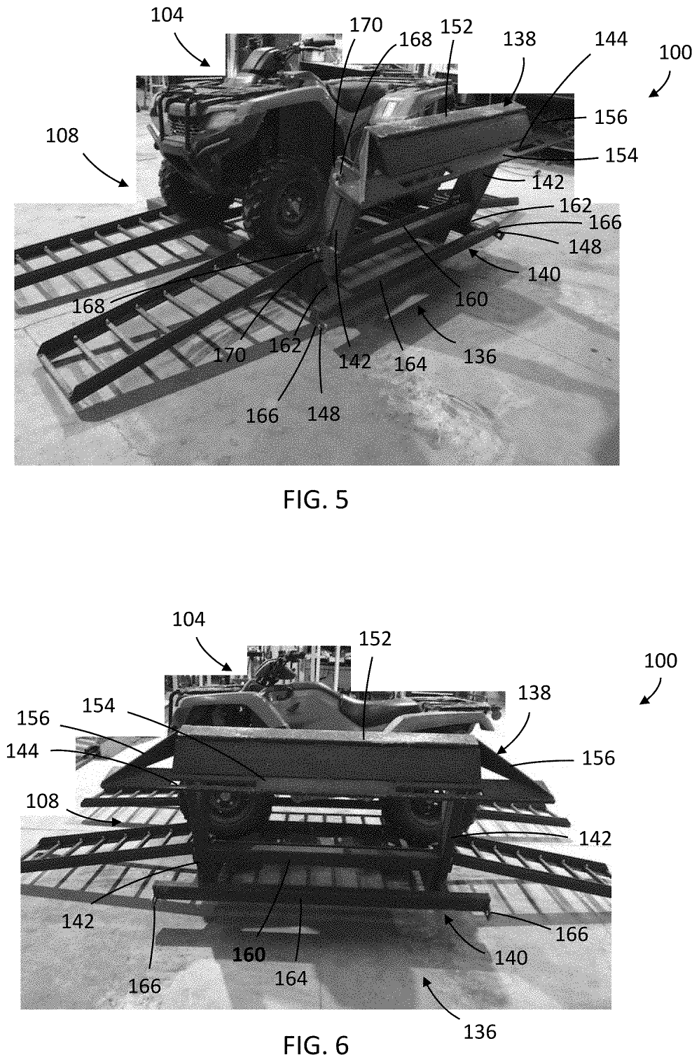

With further reference to FIG. 3, the illustrated frame 108 generally includes a forward member 114 and first and second generally L-shaped side members 116, 118. The side members 116, 118 each include a leg 120, and a body 122 extending generally vertically from the leg 120 (thereby providing the generally L shape). The forward member 114, then, is coupled to an end portion of the leg 120 of each of the side members 116, 118. It should be appreciated that in other example embodiments, the frame 108 may have other constructions and/or configurations than illustrated herein. For example, the frame 108 may include the forward member 114 (or not) and one or more additional cross members extending between the side members 116, 118 at a location(s) away from the end portion of the leg 120 of each of the side members 116, 118 (e.g., between the legs 120 of the side members 116, 118, between the bodies 122 of the side members 116, 118, combinations thereof, etc.) (e.g., to provide additional strength, support, stability, etc. to the frame 108). In one such embodiment, the frame 108 may include the forward member 114 extending between the side members 116, 118 (at the end portion of each leg 120 of the side members 116, 118 as illustrated) and an additional cross member extending between the body 122 of the first side member 116 and the body 122 of the second side member 118.

The first and second guides 110, 112 are each coupled to the leg 120 of the first side member 116 and also to the leg 120 of the second side member 118. In particular, the first guide 110 is coupled to the leg 120 of the first side member 116 adjacent the body 122 of the first side member 116 and to the leg 120 of the second side member 118 adjacent the body 122 of the second side member 118. In connection therewith, the first guide 110 may be coupled to the leg 120 of each of the side members 116, 118 by any suitable means within the scope of the present disclosure, including, for example, by one or more mechanical fasteners (e.g., by bolts, etc.), by one or more welds, by one or more friction couplings, etc.

The second guide 112 is coupled to the leg 120 of the first side member 116 and the leg 120 of the second side member 118 at a location spaced apart from the first guide 110 (and generally parallel thereto). In addition in the illustrated embodiment, the second guide 112 is coupled to the leg 120 of the first side member 116 at or within a slot 126 (or groove or track or channel, etc.) defined in (or by) the leg 120 of the first side member 116, and is similarly coupled to the leg 120 of the second side member 118 at or within a slot 126 (or groove or track or channel, etc.) defined in (or by) the leg 120 of the second side member 118. In this way, the second guide 112 is selectively adjustable (e.g., moveable, slidable, etc.) relative to the side members 116, 118 (and, more broadly, relative to the frame 108 and relative to the first guide 110), such that a distance or spacing between the first guide 110 and the second guide 112 may be modified (e.g., to accommodate different vehicles having different left and right wheel spacings, etc.). In particular, the second guide 112 may be moved along the side members 116, 118 to a desired position (relative to the first guide 110), via the corresponding slots 126, and then secured in place to the side members 116, 118. That said, the second guide 112 may be moveable relative to the legs 120 of the first and second side members 116, 118, via the slots 126 or otherwise, through any suitable means within the scope of the present disclosure, including, for example, one or more mechanical fasteners positioned within the slots (e.g., a bolt, etc.), one or more rollers associated with the legs 120, one or more bearings associated with the legs 120, etc. Further, the second guide 112 may be selectively coupled to (e.g., secured to, etc.) the legs 120 of side members 116, 118, at or within the corresponding slots 126, by any suitable means within the scope of the present disclosure, including, for example, by one or more mechanical fasteners, one or more grooves, by one or more detents, etc.

In other example embodiments, the first guide 110 may be coupled to the first and second side members 116, 118 of the frame 108 in a manner such that the first guide 110 is moveable relative to the side members 116, 118 (in addition to the second guide 112 being moveable). Or, the first guide 110 may be coupled to the first and second side members 116, 118 of the frame 108 in a manner such that the first guide 110 is moveable relative to the side members 116, 118 while the second guide 112 is fixedly coupled to the first and second side members 116, 118 (such that the second guide 112 is not moveable).

In the illustrated embodiment, end sections 110a-b, 112a-b of the first and second guides 110, 112 both extend generally past or beyond the platform 100 (e.g., beyond the legs 120 of the first and second side members 116, 118, etc.), and both are angled generally downward (e.g., toward a ground surface, etc.). As such, the end sections 110a-b, 112a-b generally provide a ramp (or ramp portion or ramp section) for moving the vehicle 104 onto the platform 100 (and onto portions of the first and second guides 110, 112 located between the first and second side members 116, 118 of the frame 108). In connection therewith, the end sections 110a-b, 112a-b of the guides 110, 112 may define separate sections of the guides 110, 112 (separate from the portions of the guides 110, 112 coupled to the frame 108 between the side members 116, 118), whereby the separate section may be coupled to the legs 120 of the first and second side members 116, 118 in a manner to provide the generally downward angle. Alternatively, the end sections 110a-b, 112a-b of the guides 110, 112 may simply be bent and thereby angled generally downwardly. Further, in some example embodiments, the end sections 110a-b, 112a-b of the guides 110, 112 may be pivotable (e.g., hingedly coupled to the side members 116, 118 of the frame 108, hingedly coupled to the portions of the guides 110, 112 positioned between the side members 116, 118 of the frame 108, etc.) between a generally downward position for moving the vehicle 104 onto the platform 100 and a generally upward positon for storage or transport (e.g., when coupled on the combine 102, etc.).

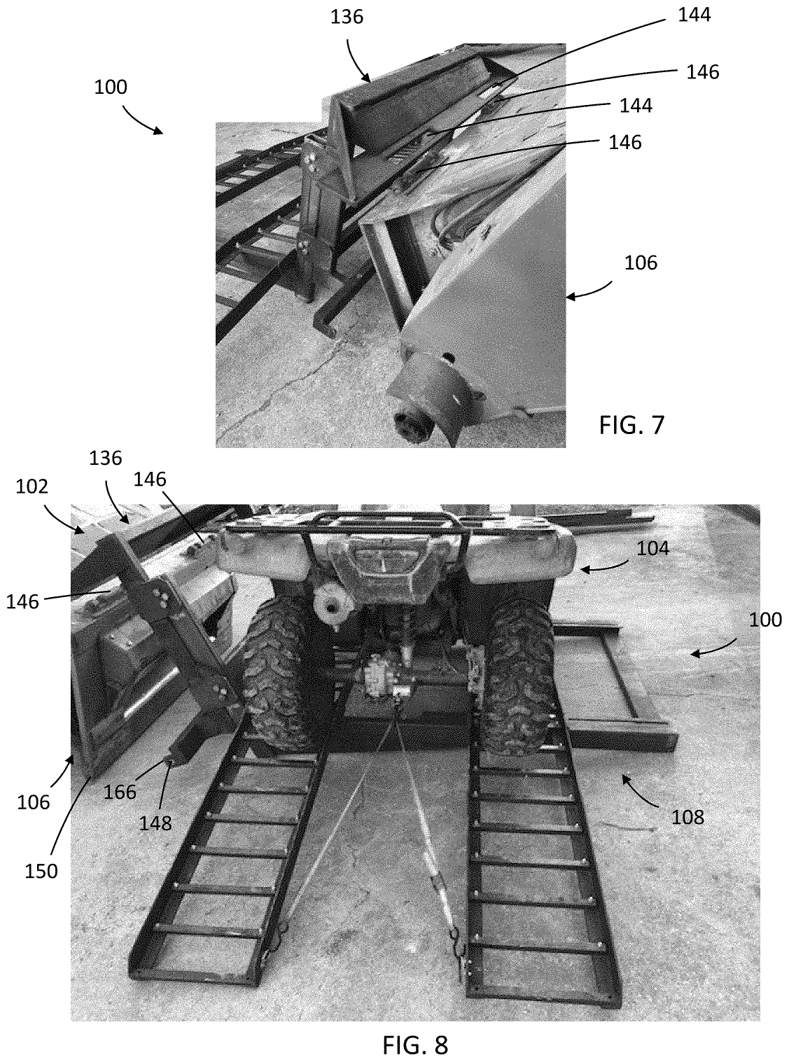

As shown in FIG. 4, the first and second guides 110, 112 each include a pair of side rails 128, 130, and multiple rungs 132 extending between the side rails 128, 130 along a length of the respective guide 110, 112. In the illustrated embodiment, each of the side rails 128, 130 defines a generally L-shaped cross-section. And, the rungs 132 are positioned on a flange 134 of each of the side rails 128, 130 and coupled thereto. The rungs 132 may be coupled to the flanges 134 of the side rails 128, 130 by any suitable means within the scope of the present disclosure, including, for example, by one or more mechanical fasteners (e.g., bolts, etc.), by one or more welds, etc. What's more, any desired spacing(s) for the rungs 132 may be used within the scope of the present disclosure, so long as the spacing(s) is/are sufficient to support the vehicle 104 on the guides 110, 112 and/or platform 100 (e.g., a spacing(s) of about five inches, about six inches, about seven inches, about eight inches, a spacing(s) therebetween, etc.). In other embodiments, the rungs 132 may alternatively (or additionally) be coupled to a side wall 135 of each of the side rails 128, 130. For instance, the side wall 135 of each of the side rails 128, 130 (of each guide 110, 112) may include multiple aligned openings along its length. Each of the rungs 132 may then extend through corresponding ones of the openings in each side wall 135, and then be pinned in place and/or coupled (e.g., welded, fastened by one or more mechanical fasteners, etc.) to the side wall 135 (whereby the rungs 132 would still be arranged generally as shown in FIG. 4).

That said, in some example embodiments, a single sheet of material may be positioned between the side rails 128, 130 of each of the guides 110, 112 (instead of or in addition to the rungs 132) to thereby provide a surface to support the vehicle 104 on the guide(s) (and, thus, on the platform 100). Further, in some example embodiments, the guides 110, 112 may each include a single sheet of material (e.g., where the guides 110, 112 are each a sheet of material without side rails or rungs, etc.) to thereby provide a surface to support the vehicle 104 on the platform 100.

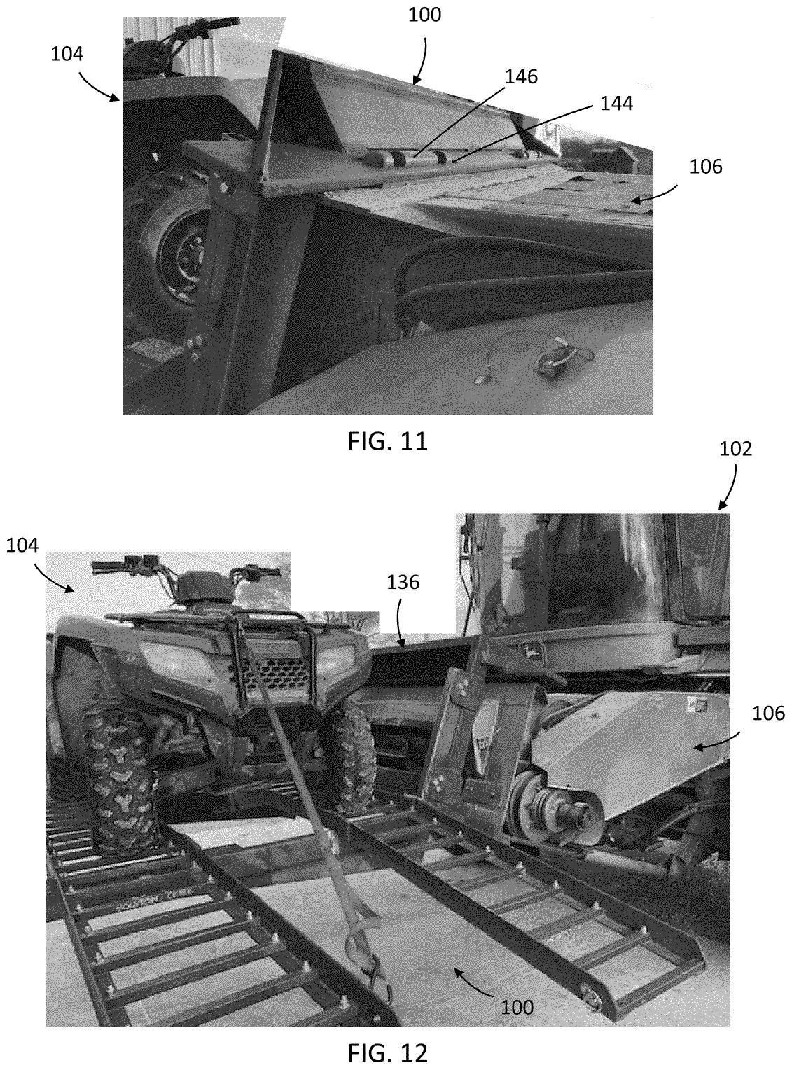

With reference now to FIGS. 5 and 6, the platform 100 also includes a mount 136 coupled to the frame 108 and configured to connect the frame 108 to the combine 102. In particular in the illustrated embodiment, the mount 136 is configured to couple the platform 100 to the combine 102 at (or adjacent) the feeder house 106 of the combine 102 (FIG. 1) (e.g., to a front portion or front housing of the combine 102, etc.). In connection therewith, the illustrated mount 136 generally includes an upper support 138, a lower support 140, and first and second sides (each indicated at 142) coupled between the upper support 138 and the lower support 140 (and generally coupling the upper support 138 to the lower support 140). The upper support 138 then (and broadly, the mount 136) includes openings (each indicated at 144) configured (e.g., sized, spaced, located, etc.) to receive lugs (each indicated at 146) (broadly mounting structure) of the combine 102 (FIG. 7), disposed at (or adjacent) the feeder house 106, to thereby position (e.g., releasably couple, removeably couple, etc.) the platform 100 on the combine 102. And, the lower support 140 includes openings (each indicated at 148) configured (e.g., sized, spaced, located, etc.) to receive support pins 150 (FIGS. 13 and 14) (only one is shown) of the combine 102 disposed at (or adjacent) the feeder house 106 to further secure (e.g., releasably couple, removeably couple, etc.) the platform 100 on the combine 102. Operation of coupling the platform 100 to the combine 102, at (or adjacent) the feeder house 106, will be described in more detail hereinafter.

In the illustrated embodiment, the upper support 138 of the mount 136 generally includes a cap 152, a face portion 154 disposed adjacent the cap 152, and wings 156 extending from the sides 142 (and/or upper support 138) of the mount 136 to the face portion 154. The cap 152 is positioned on end portions of the sides 142 and is coupled (e.g., welded, etc.) thereto. The face portion 154 is coupled to a lower lip portion of the cap 152, generally rearward of the sides 142. And, the wings 156 are coupled to the sides 142 (and/or the upper support 138) and to the face portion 154 to provide support, stability, etc. to the mount 136. The face portion 154 of the mount 136, then, includes the openings 144 configured to receive the lugs 146 of the combine 102 (FIG. 7) to thereby couple the platform 100 to the combine 102. That said, it should be appreciated that the upper support 138 of the mount 136 may have other configurations within the scope of the present disclosure, and still capable of coupling the platform 100 to the combine 102.

Also in the illustrated embodiment, the lower support 140 of the mount 136 includes a first cross member 160 extending generally between the first and second sides 142 of the mount 136, first and second spacers (each indicated at 162) coupled to lower end portions of the first and second sides 142, and a second cross member 164 coupled to the spacers 162. The second cross member 164 is disposed generally below the face portion 154 of the upper support 138 and includes tabs 166 disposed toward end portions thereof. The tabs 166 define the openings 148 configured to receive the pins 150 of the combine 102 to further secure (selectively) the platform 100 to the combine 102.

Uniquely herein, the mount 136 is releasably coupled to the frame 108 whereby the mount 136 may be interchanged with other mounts, for example, to accommodate coupling the platform 100 to different combines (e.g., combines from different manufacturers, different models of combines, etc.). In the illustrated embodiment, the mount 136 is releasably coupled to the frame 108 by mechanical fasteners 168 (FIG. 5). In particular, mounting tabs 170 are coupled (e.g., welded, etc.) to the sides 142 of the mount 136, and bolts (e.g., fasteners 168, etc.) are positioned through openings of the mounting tabs 170 and into corresponding openings of the bodies 122 of the frame 108 to thereby couple the mount 136 to the frame 108. In connection therewith, when desired to utilize the platform 100 with a different combine, the bolts (e.g., fasteners 168, etc.) can be removed from the mounting tabs and the mount 136 can be removed from the frame 108. The desired different mount can then be attached to the frame 108 in the same manner, by way of positioning the bolts (e.g., the fasteners 168, etc.) through openings of mounting tabs of the desired different mount and into the corresponding openings of the bodies 122 of the frame 108. That said, it should be appreciated that the mount 136 may be releasably, interchangeably, etc. coupled to the frame 108 otherwise in other embodiments. For instance, one or more quick connect fasteners may be used to couple the mount 136 to the frame 108, etc.

In the illustrated embodiment, the example mount 136 is configured to couple the platform 100 to the combine 102, which is manufactured by Deere and Company. Other mounts (other than mount 136) may be usable with the frame 108 (and coupled thereto as described above for the mount 136), whereby the other mounts then may be configured to couple the platform 100 to combines from other manufactures (where the other mounts of the platform 100 are then configured to match or otherwise correspond to mounting structures of the combines from the other manufacturers so that the platform 100 can be supported by the other combines via their particular mounting structures). Further, in still other embodiments, the platform 100 may be used with combines having moveable mounting structure components, for example, moveable locking pins, etc. (e.g., instead of lugs 146, etc.), configured for coupling attachments to the combines, whereby the platform 100 may include a mount having openings, detents, or other structure particularly configured to receive the moveable components of the combines to thereby releasably, removeably, etc. couple the platform 100 to the combines.

Referring now to FIGS. 7-14, an example operation of coupling the platform 100 to the combine 102 will be described. As shown in FIGS. 7 and 8, in this example, the combine 102 is initially positioned adjacent the platform 100 (where the platform 100 is resting on a ground surface), with the feeder house 106 generally facing the mount 136. And, the lugs 146 of the combine 102 (generally disposed on top of the feeder house 106) are positioned generally below the openings 144 of the face portion 154 of the upper support 138 (e.g., the combine 102 is operated to pivot the feeder house 106 to position the lugs 146 generally below the openings 144, etc.). At about the same time, or before or after, the vehicle 104 is positioned on the platform 100 and secured thereto (e.g., via one or more tie-downs secured to attachment points on the platform 100, etc.) (FIGS. 8 and 12).

Next, the lugs 146 of the combine 102 are moved into the openings 144, for example, by operating the combine 102 to pivot the feeder house 106 generally upward, and the platform 100 (and vehicle 104) is generally elevated off (and above) the ground surface. In doing so, the second cross member 164 of the lower support 140 of the mount 136 moves into position adjacent a lower portion of the feeder house 106, and the openings 148 of the mounting tabs 166 generally align with the pins 150 of the combine 102 (FIGS. 12-14). The pins 150 of the combine 102 are then operated (e.g., manually moved, pneumatically moved, electrically moved, hydraulically moved, etc.) to move the pins 150 into the openings 148. The platform 100 is thus coupled to the combine 102, and the combine 102 may be driven with the platform 100 and vehicle 104 thereon.

While the above describes use of the platform 100 with the combine 102, it should be appreciated that the platform 100 may also be used with machinery other than combines in other embodiments to allow for supporting vehicles on the platform 100 and then transporting the vehicles by the machinery. For example, the platform 100 may be used with loaders, tractors, backhoes, skidders, or other machinery (e.g., agricultural machinery, construction machinery, machinery having wheels, machinery having tracks, drivable or moveable machinery, etc.) configured for use with different attachments. In doing so, a mount of the platform 100 may include one or more openings, detents, recesses, other structure, etc. in its upper support configured (e.g., sized, shaped, located, etc.) to receive or otherwise connect to corresponding mounting lugs, clasps, locking pins, etc. (broadly, mounting structures) of the loaders, tractors, backhoes, skidders, or other machinery to which the platform 100 is to be attached. The platform 100 may then be releasably or removeably coupled to the loaders, tractors, backhoes, skidders, or other machinery and used as described herein. In some example embodiments, the mounting lugs, clasps, locking pins, etc. (broadly, mounting structures) of the loaders, tractors, backhoes, skidders, or other machinery may be located toward or located on (or associated with) a front portion (or front housing, etc.) of the loaders, tractors, backhoes, skidders, or other machinery whereby the platform 100 may be coupled to (and/or disposed toward) the front portion (or front housing, etc.) of the loaders, tractors, backhoes, skidders, or other machinery.

The foregoing description of the embodiments has been provided for purposes of illustration and description. It is not intended to be exhaustive or to limit the present disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the present disclosure, and all such modifications are intended to be included within the scope of the present disclosure.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, components, and/or groups thereof, but do not preclude the presence or addition of one or more other features, integers, steps, operations, elements, components, and/or groups thereof.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A platform for supporting a vehicle on a combine, the platform comprising:
a frame;
at least one guide supported by the frame, the at least one guide configured to receive at least one wheel of a vehicle to thereby position the vehicle on the frame; and
a mount coupled to the frame and configured to connect the frame to a feeder house of the combine.

2. The platform of claim 1, wherein the at least one guide includes a first guide and a second guide, and wherein the first guide is disposed on the fame generally parallel to the second guide.

3. The platform of claim 2, wherein the at least one wheel of the vehicle includes multiple wheels, and wherein the first and second guides each define a track configured to allow ones of the multiple wheels to roll along a surface of the track.

4. The platform of claim 3, wherein each of the first and second guides includes multiple rungs defining the corresponding track of the first and second guides.

5. The platform of claim 1, wherein the at least one guide extends beyond the frame to thereby provide a ramp portion for positioning the vehicle on the frame.

6. The platform of claim 1, wherein the frame defines a generally rectangular shape.

7. The platform of claim 1, wherein the mount defines a first opening configured to receive a lug of the feeder house for use in coupling the platform to the feeder house.

8. The platform of claim 7, wherein the mount further defines a second opening configured to receive a support pin of the combine.

9. The platform of claim 8, wherein the second opening is located generally below the first opening.

10. A combine, comprising:
a feeder house; and
a platform configured to support a vehicle on the combine, wherein the platform includes:
a frame;
at least one guide supported by the frame, the at least one guide configured to receive at least one wheel of a vehicle to thereby position the vehicle on the frame; and
a mount coupled to the frame and configured to connect the frame to the feeder house of the combine.

11. The combine of claim 10, wherein the feeder house includes a lug, and wherein the mount defines a first opening configured to receive the lug of the feeder house for use in coupling the frame to the feeder house.

12. The combine of claim 11, further comprising a support pin associated with the feed house;
wherein the mount further defines a second opening configured to receive the support pin of the combine.

13. The combine of claim 12, wherein the second opening is located generally below the first opening.

14. A platform for connecting to mounting structure of a machine for supporting a vehicle on the machine, the platform comprising:
a frame;
at least one guide supported by the frame, the at least one guide configured to receive at least one wheel of a vehicle to thereby position the vehicle on the frame; and
a mount coupled to the frame and configured to connect the frame to a front housing of the machine.

15. The platform of claim 14, wherein the at least one guide includes a first guide and a second guide, and wherein the first guide is disposed on the fame generally parallel to the second guide.

16. The platform of claim 15, wherein the at least one wheel of the vehicle includes multiple wheels, and wherein the first and second guides each define a track configured to allow ones of the multiple wheels to roll along a surface of the track.

17. The platform of claim 16, wherein each of the first and second guides includes multiple rungs defining the corresponding track of the first and second guides.

18. The platform of claim 14, wherein the at least one guide extends beyond the frame to thereby provide a ramp portion for positioning the vehicle on the frame.

19. The platform of claim 14, wherein the frame defines a generally rectangular shape.

20. The platform of claim 14, wherein the machine is selected from the group consisting of a combine, a loader, a tractor, a backhoe, and a skidder.
